(19) United States
(12) Patent Application Publication
(10) Pub. No.: US 2018/0211774 A1
(43) Pub. Date: Jul. 26, 2018

(54) Method and Apparatus for Harvesting Electrical Energy from Current Carrying Elongate Conductors

(71) Applicant: Sky Sight Technologies, LLC, Leo, IN (US)

(72) Inventors: Patrick R. McCammon, Leo, IN (US); Andrew Rekeweg, Woodburn, IN (US)

(73) Assignee: Sky Sight Technologies, LLC, Leo, IN (US)

(21) Appl. No.: 15/878,716

(22) Filed: Jan. 24, 2018

Related U.S. Application Data
(60) Provisional application No. 62/450,429, filed on Jan. 25, 2017.

(51) Int. Cl. H01F 38/22; H01F 27/02; H01F 27/06; H01F 27/245; H01F 27/26; H01F 41/02

(52) U.S. Cl. CPC H01F 38/22; H01F 27/022; H01F 27/027; H01F 41/0233; H01F 27/245; H01F 27/263; H01F 27/06

(57) ABSTRACT

An energy harvesting method and apparatus for harvesting electrical energy from an elongate conductor through which alternating electrical current is flowing. The apparatus includes a magnetically permeable ferromagnetic metal U-shaped core. An electromagnetic coil surrounds the central section of the core. The core legs form an opening leading to a gap between the legs. The opening and gap are larger than the cross section of the conductor. The conductor is received through the opening into the gap whereat the flowing alternating electric current electromagnetically couples with the core and induces electric current in the coil. The opening is maintained open for selectively removing the conductor therethrough. The apparatus is encapsulated within an electrically insulative housing for electrically insulating and preventing physical contact with the conductor. The apparatus powers an electronic circuit which senses and transmits, via electromagnetic radiation, the operational status of the conductor.

### CROSS REFERENCE TO RELATED APPLICATIONS

This application claims priority under 35 U.S.C. 119(e) of U.S. provisional patent application Ser. No. 62/450,429 filed on Jan. 25, 2017 entitled ENERGY HARVESTING APPARATUS AND METHOD, the disclosure of which is hereby incorporated herein by reference.

### BACKGROUND OF THE INVENTION

### 1. Field of the Invention

The present invention relates to the field of harvesting electrical energy. More particularly, the present invention relates to methods and apparatus for harvesting electrical energy from elongate conductors, such as power transmission lines, through which alternating electrical current is traveling, without physically contacting the elongate conductor.

### 2. Background

Energy harvesting apparatus for harvesting electrical energy from elongate electrical conductors carrying alternating current are today well known and commonly used. They are, for example, used to harvest electrical energy from power transmission lines and to power electronic circuits used for various purposes, including powering sensors and electronics which determine the status of the power transmission line and transmit such status via electromagnetic radiation.

Some of the known electrical energy harvesting apparatus utilize wire coils or a counterpoise adjacent the elongate conductor. The coils and counterpoise magnetically couple with the elongate conductor for thereby harvesting the energy. Examples of such prior electrical energy harvesting apparatus are shown and described in Schweitzer, Jr., U.S. Pat. No. 3,708,724 and U.S. Pat. No. 4,424,512, and McCollough, Jr., U.S. Pat. No. 7,295,133. Although these electrical energy harvesting apparatus function sufficiently for their intended purpose, their power output relative to their size is limited.

Other electrical energy harvesting apparatus utilize a toroidal core which completely surrounds the elongate conductor. A coil is wound on the toroid core for thereby harvesting the energy from the elongate conductor. Examples of such prior electrical energy harvesting apparatus are shown and described in Fernandes, U.S. Pat. No. 4,801,937 and Joseph et al. US 2017/0045571. Although these electrical energy harvesting apparatus also function sufficiently for their intended purpose, the toroid structure makes it cumbersome and difficult to install on and remove from existing elongate conductors. Consequently, the toroid is typically split and the sections thereof must be separated for installing on or removing from the conductor, thereby necessitating additional mechanical components for this purpose.

Accordingly, a need exists for a method and apparatus for harvesting electrical energy from current carrying elongate conductors wherein the energy harvesting apparatus can easily be installed on and removed from an existing elongate conductor, and which is capable of harvesting a greater amount of power relative to its size and the prior known harvesters.

### SUMMARY OF THE INVENTION

The present invention overcomes disadvantageous of prior electrical energy harvesting apparatus; is capable of harvesting more energy than prior known energy harvesters; and, can be more easily installed on and removed from an existing elongate conductor.

In one form thereof the present invention is directed to a method of harvesting electrical energy from an elongate conductor through which alternating electrical current is traveling. The method includes the steps of: providing a U-shaped core comprising a central section and first and second legs extending from the central section, and defining an opening leading to a gap between the first and second legs, wherein the opening and gap are larger than a cross section of the elongate conductor and wherein the central section and the first and second legs comprise magnetically permeable material; providing an electromagnetic coil comprising magnet wire wound around the central section and having terminal ends; inserting the elongate conductor though the opening and into the gap between the first and second legs; preventing the elongate conductor from physically contacting the first and second legs and the electromagnetic coil; electromagnetically coupling the alternating electric current traveling through the elongate conductor with the U-shaped core and inducing electric current in the electromagnetic coil and providing electric current at the magnet wire terminal ends; and, during the step of electromechanically coupling, maintaining the opening open for selectively removing the elongate conductor therethrough.

Preferably, during the step of providing a U-shaped core, further including the step of constructing the U-shaped core by stacking a plurality of U-shaped sheets, wherein each U-shaped sheet comprises a central section and first and second legs extending from the central section. Also, during the step of providing a U-shaped core, the method can include the step of constructing the U-shaped core of ferromagnetic metal. Further, during the step of providing an electromagnetic coil, the method can include the step of winding the magnet wire around the central section more than 5,000 times.

The method can also include the steps of: coupling the magnet wire terminal ends to and powering an electronic circuit for sensing and transmitting via electromagnetic radiation the operational status of the elongate conductor, encapsulating the U-shaped core, the electromagnetic coil and the electronic circuit within an insulative housing; securing the insulative housing to an insulator supported on an elongate pole and which supports the elongate conductor; and, during the step of providing a U-shaped core, further comprising the step of constructing the U-shaped core by stacking a plurality of U-shaped sheets, wherein each U-shaped sheet comprises a central section and first and second legs extending from the central section.

In another form thereof the present invention is directed to an apparatus for harvesting electrical energy from an elongate conductor through which alternating electrical current is traveling. The apparatus includes a U-shaped core having a central section and first and second legs extending from the central section, and defining an opening leading to a gap between the first and second legs. The central section and the first and second legs are made of magnetically permeable material. An electromagnetic coil is provided and is made of magnet wire wound around the central section and having terminal ends. The elongate conductor is received though the opening and is located in the gap between the first and second legs, and does not physically contact the first and second legs and the electromagnetic coil. The alternating electric current traveling through the elongate conductor thereby electromagnetically couples with the U-shaped core and induces electric current in the electromagnetic coil for providing electric current at the magnet wire terminal ends.

Preferably, the magnetically permeable material forming the U-shaped core is paramagnetic and is a made of a ferromagnetic metal. The U-shaped core central section and first and second legs can be integrally formed. Alternatively, the first and second legs can be secured to the central section with fasteners. Preferably, the U-shaped core is made of a plurality of stacked U-shaped sheets, wherein each U-shaped sheet has a central section and first and second legs extending from the central section. Preferably, the magnet wire is wound around the central section more than 5,000 times. More preferably, the magnet wire is 33 AWG and is wound around the central section more than 9,000 times.

The first and second legs are preferably encapsulated within an insulative material and an electrically insulative material layer is provided between the elongate conductor and the U-shaped core and electromagnetic coil.

The magnet wire terminal ends can be coupled to and power an electronic circuit for sensing and transmitting, via electromagnetic radiation, the operational status of the elongate conductor. The U-shaped core, the electromagnetic coil and the electronic circuit can be encapsulated within an insulative housing. The insulative housing can then be secured to an insulator affixed to a cross arm of an elongate vertical pole and which supports the elongate conductor.

### BRIEF DESCRIPTION OF THE DRAWINGS

The above mentioned and other features and objects of this invention, and the manner of attaining them, will become more apparent and the invention itself will be better understood by reference to the following description of the embodiments of the invention taken in conjunction with the accompanying drawings, wherein:

FIG. 1 is a perspective view of elongate conductors/transmission lines supported on vertical poles and from which the energy harvesting apparatus of the present invention can harvest electrical energy;

FIG. 2 is an electrical energy harvesting apparatus, constructed in accordance with the principles of the present invention, which is incorporated within a jaw member used for securing an elongate conductor/transmission line shown in FIG. 1 to a supporting insulator;

FIG. 3 is an exploded view of the supporting insulator and jaw member shown in FIG. 2, and also showing the energy harvesting apparatus constructed in accordance with the principles of the present invention and connected to an electronic circuit;

FIG. 4 is a perspective view showing the several components depicted in FIG. 3 in their assembled state;

FIG. 5 is similar to FIG. 4 and showing a potting compound encapsulating the energy harvesting apparatus and the electronic circuit within the jaw member housing;

FIG. 6 is an exploded view of the energy harvesting apparatus shown in FIG. 3;

FIG. 7 is a cross sectional view of the jaw member and energy harvesting apparatus taken along line 7-7 of FIG. 2;

FIG. 8 is a perspective view of an alternate embodiment of an energy harvesting apparatus constructed in accordance with the principles of the present invention;

FIG. 9A is perspective view of a testing arrangement for measuring the power harvested by a coil and core harvester relative to the distance between the coil and the elongate conductor;

FIG. 9B is perspective view of a testing arrangement for measuring the power harvested by an energy harvesting apparatus constructed in accordance with the principles of the present invention, relative to the distance between the coil and the elongate conductor;

FIG. 10 shows the circuit of the testing arrangements of FIGS. 9A and 9B and the voltage and power output thereof in Tables 1 and 2; and,

FIG. 11 is a graph showing the power output of the coil and core harvester of FIG. 9A and of the energy harvesting apparatus of FIG. 9B, relative to the distance between the coil and the elongate conductor.

Corresponding reference characters indicate corresponding parts throughout several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENTS

An energy harvesting apparatus constructed in accordance with the principles of the present invention is shown in the drawings and generally designated by the numeral 10. Energy harvesting apparatus 10 is adapted to harvest electrical energy from an elongate conductor through which alternating electrical current is traveling, without physically contacting the elongate conductor.

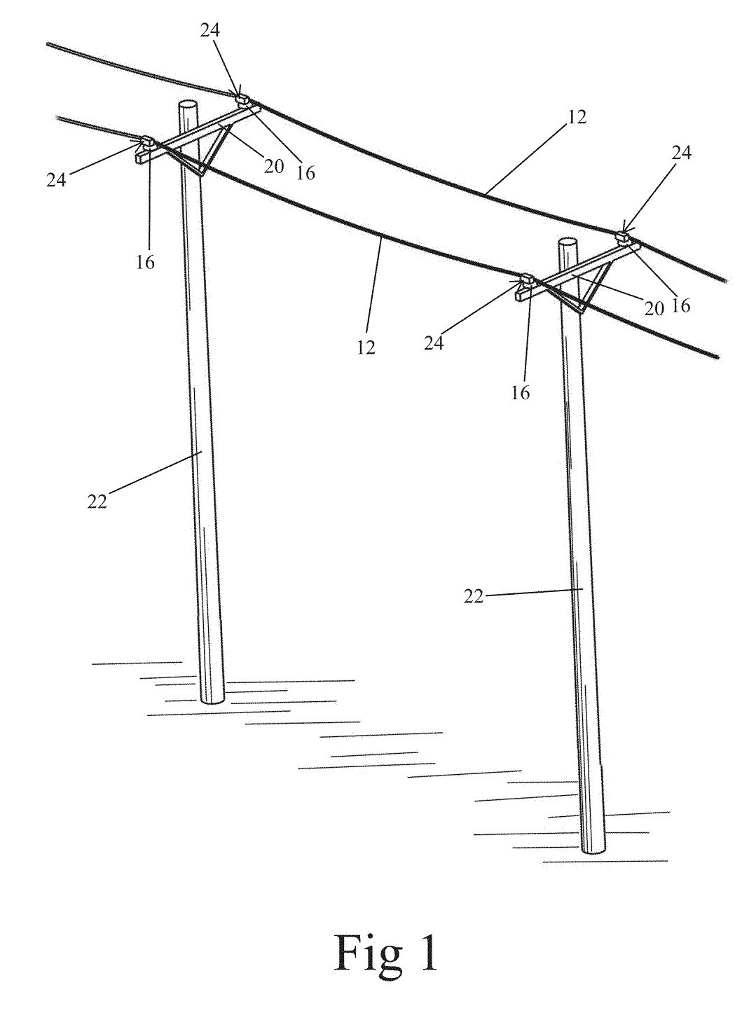

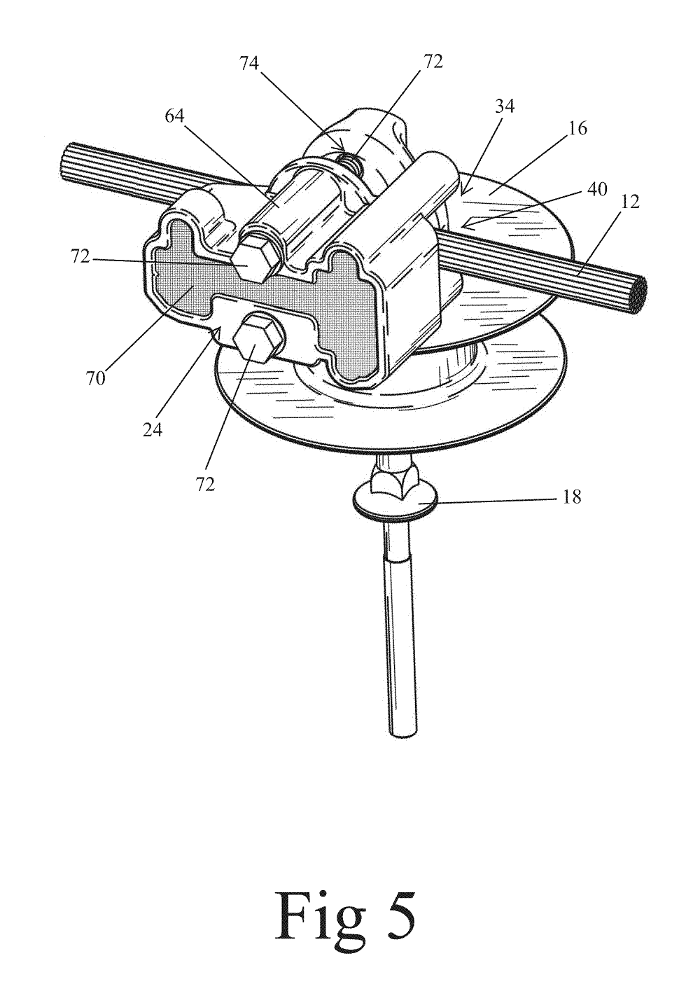

For example, referring to FIGS. 1-5, energy harvesting apparatus 10 can be used to harvest electrical energy from a power transmission elongate conductor 12 which is typically used to transmit electrical energy from a power station to buildings and homes. Such elongate conductors 12 can, for example, be type AAC, 556 gauge, operating at 1 KV to 138 KV and transmitting currents in the neighborhood of 50 amps. As more fully described herein below, the energy harvested from the apparatus 10 can then be used to power an electronic circuit 14 for sensing and transmitting, via electromagnetic radiation, the operational status of the elongate conductor 12 as, for example, shown and described in Applicant's application Ser. No. 15/289,616, filed Oct. 10, 2016 and titled Wireless Power Line Sensor, the disclosure of which is expressly incorporated herein by reference. The apparatus 10 and the electronic circuit 14 are “floating”, that is, they operate without being connected to physical ground.

Further referring to the embodiment of FIGS. 1-5, the elongate conductors 12 are supported on insulators 16 which are mounted upon posts 18. The posts 18 are, in turn, secured to cross arms 20 which are affixed atop vertical poles 22. The energy harvesting apparatus 10 can be incorporated within a jaw member 24 which is used to clamp the elongate conductor 12 onto the insulator 16 and simultaneously place the energy harvesting apparatus 10 adjacent the elongate conductor 12, as needed and more fully described herein below, for harvesting electrical energy from the elongate conductor 12 and powering the electronic circuit 14 which is also incorporated within the jaw member 24.

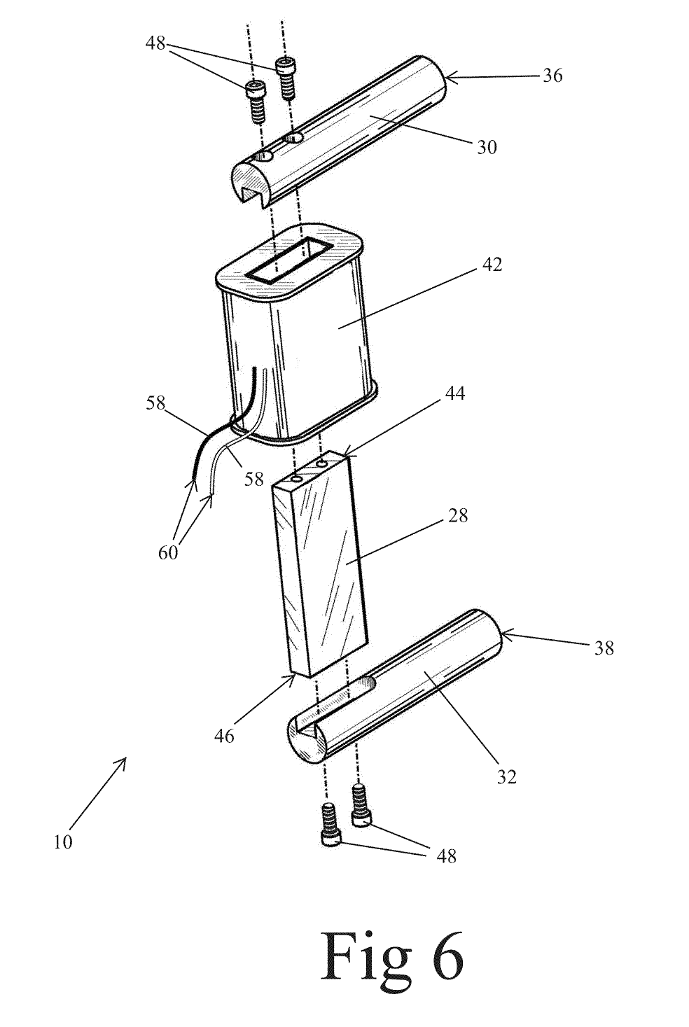

Referring now more particularly to FIGS. 6-8, the energy harvesting apparatus 10 includes a U-shaped core 26 having a central section 28 and first and second legs 30, 32 extending from the central section 28. Central section 28 and the first and second legs 30, 32 are preferably coplanar, and the first and second legs 30, 32 are parallel to each other and perpendicular to the central section 28. The U-shaped core 26 defines a high reluctance opening 34 between the respective terminal ends 36, 38 of the first and second legs 30, 32, leading to a gap 40 between the first and second legs 30, 32. The opening 34 and the gap 40 are larger than a the cross section of the elongate conductor 12 so that the conductor 12 can be received through the opening 34 and into the gap 40 and so that the conductor 12 does not physically contact either of the first and second legs 30, 32. When received within the gap 40, the elongate conductor is also not in physical contact with the electromagnetic coil 42 wound around the central section 28 as more fully described herein below.

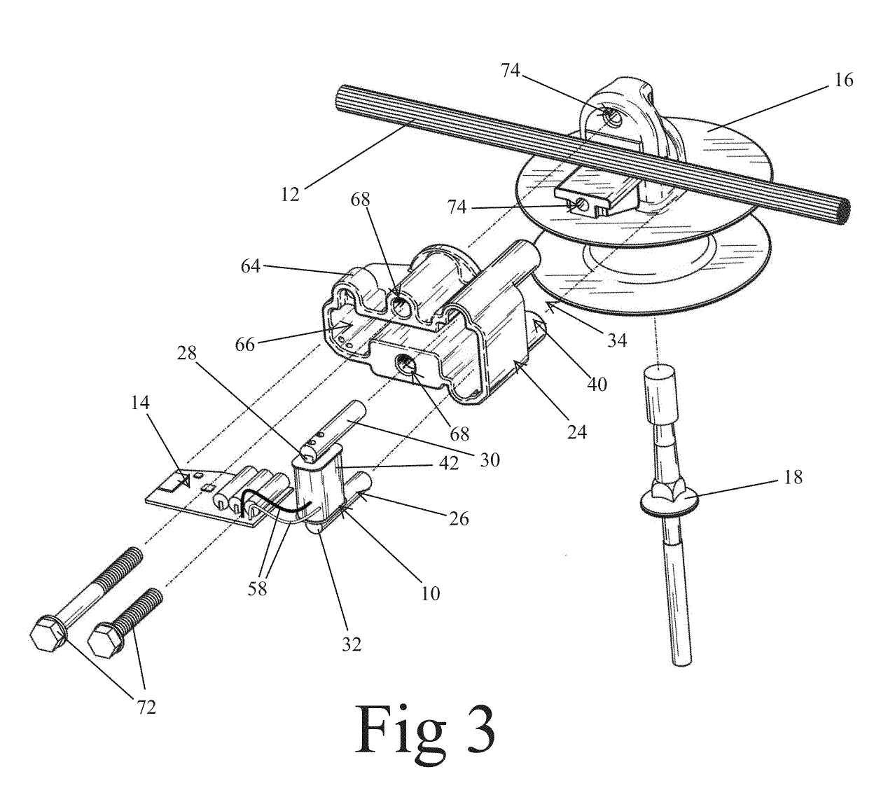

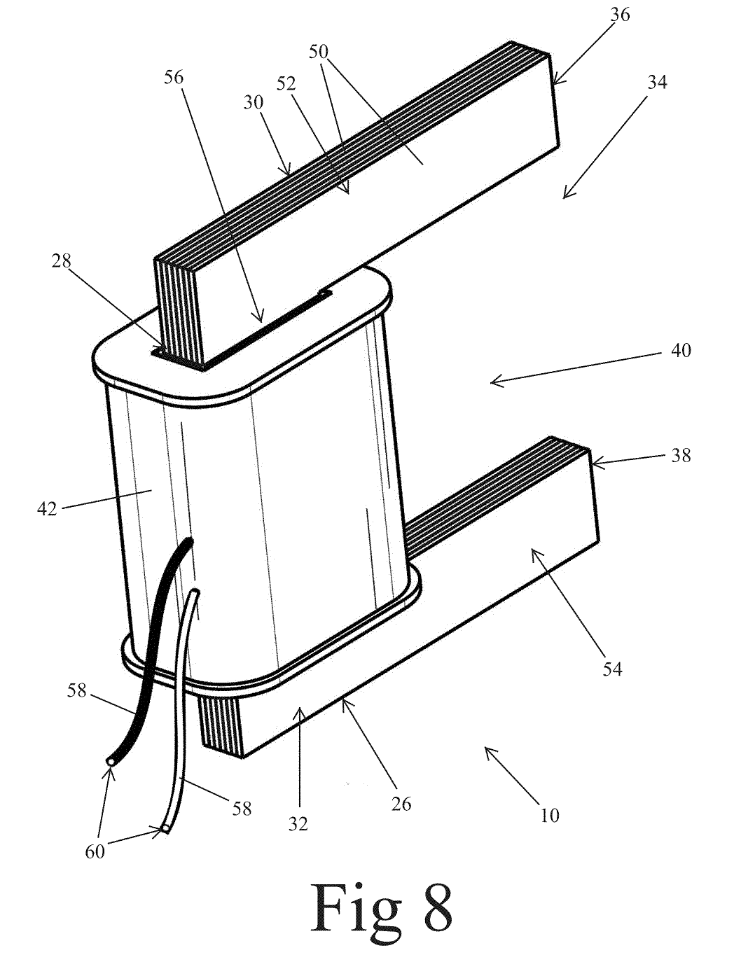

The central section 28 and the first and second legs 30, 32 forming the U-shaped section are made of magnetically permeable material which is preferably paramagnetic and which can be a ferromagnetic metal such as cast iron and electrical steel. In the embodiment shown in FIGS. 3, 6 and 7, the first and second legs 30, 32 are formed separate from the central section 28 and are secured to the respective terminal ends 44, 46 of the central section 28 with fasteners 48. Preferably, the first and second legs 30, 32 and the central section 28 are integrally formed such as by casting or by machining for eliminating the reluctance at the securement between the first and second legs 30, 32 and the respective central section terminal ends 44, 46. Yet more preferably, as shown in FIG. 8, the U-shaped core 26 is made with a plurality of stacked U-shaped metal sheets 50, each of which includes integrally formed first and second legs 52, 54 and a central section 56, for minimizing eddy current losses.

The electromagnetic coil 42 is made by winding magnet/enameled copper wire 58 around the central section 28 between the central section terminal ends 44, 46. The magnet wire 58 terminates at terminal ends 60 whereat harvested electric current is provided. Magnet wire terminal ends 60 are coupled to and provide power to the electronic circuit 14. Preferably, a relatively small diameter magnet wire 58 is wrapped around the central section 28 a relatively large number of turns for maximizing the harvested energy. Also preferably, the magnet wire 58 is wrapped around the central section 20 more than 5,000 time. More preferably, the magnet wire 58 is 33 AWG enameled copper wire wrapped around the central section more than 9,000 times.

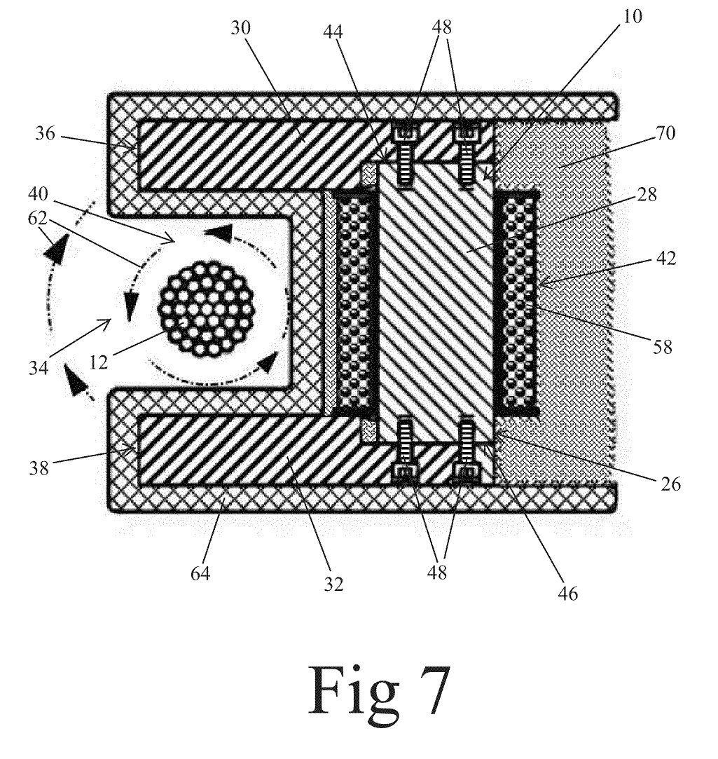

In operation, as best seen in FIG. 7, the elongate conductor 12 is received through the U-shaped core opening 34 and into the gap 40. The elongate conductor 12 is preferably located generally perpendicular to the U-shaped core upper and lower legs 30, 32. The alternating electric current traveling through the elongate conductor 12 provides alternating magnetic flux as depicted by arrows 62 which electromagnetically couples with the U-shaped core legs 30, 32 and which provides alternating magnetic flux through the U-shaped core central section 28. Hence, the U-shaped core 26 electromagnetically couples with and induces alternating electric current in the electromagnetic coil 42, thereby providing electric current at the magnet wire terminal ends 60. It is noted that, during use and operation, the high reluctance air gap opening 34 between the U-shaped leg terminal ends 36, 38 is maintained/is not closed, thereby allowing the conductor 12 to freely be placed in and removed from the gap 40 and thereby allowing the jaw member 24 to easily be secured to and detached from the insulator 16 while the conductor 12 is supported by the insulator 16. As should now be appreciated, the high reluctance opening 34 advantageously allows the jaw member 24 to easily be attached and detached from the insulator 16 thereby making servicing of the conductors 12, insulators 16, cross arms 20, poles 22, etc. substantially easier.

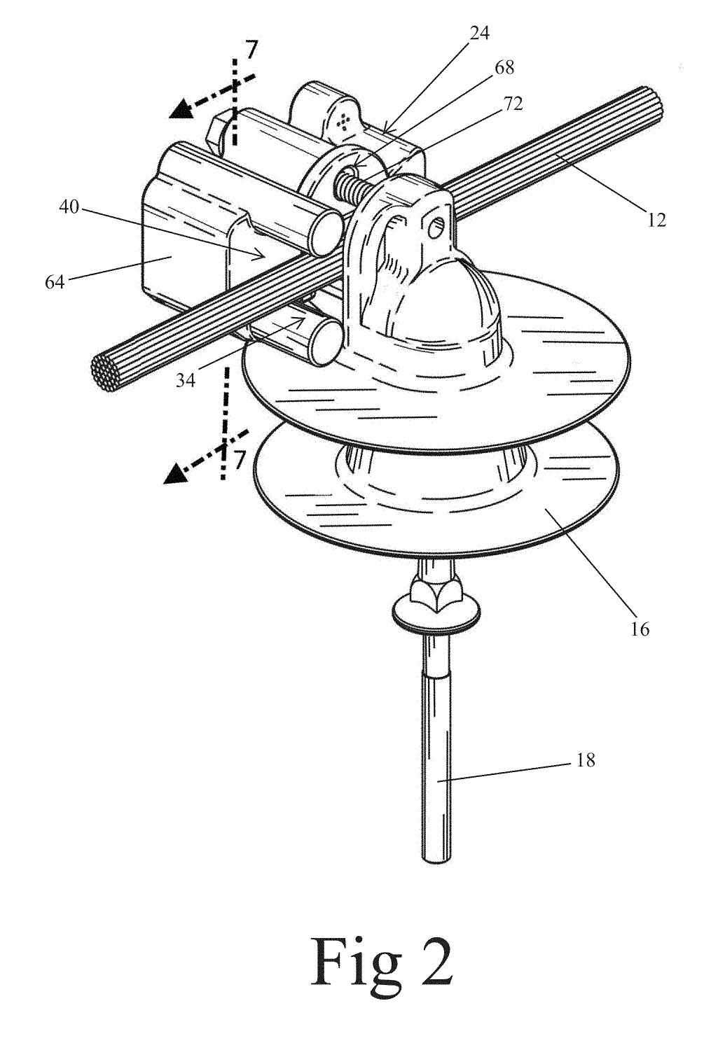

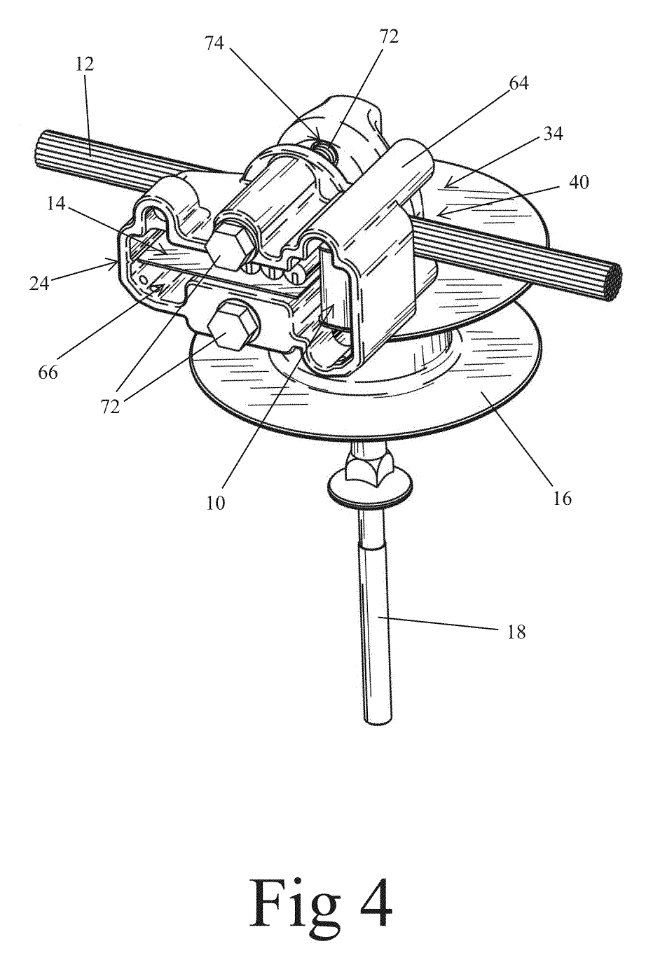

Referring now again to FIGS. 2-5, the jaw member 24 includes a housing 64 defining a cavity 66 and bolt receiving apertures 68. Housing 64 is made of an insulative material such as ultra-high-molecular-weight polyethylene (UHMW), preferably by injection molding. After the magnet wire terminal ends 60 are connected to the electronic circuit 14, the apparatus 10 and the electronic circuit 14 are inserted into the housing cavity 66 as depicted and shown in FIGS. 3 and 4. A potting insulative material 70 such as a polyurethane potting material is then poured into the housing cavity 66 thereby encapsulating the apparatus 10 and the electronic circuit 14 and securing them within the housing 64. The jaw member 24 can then be secured to the supporting insulator 16 with bolts 72 extending through the housing apertures 68 and threadingly engaging the threaded bores 74 formed in the insulator 16. As should now be appreciated, the jaw member 24 is selectively easily attachable and detachable to the insulator 16 using the bolts 72 and, when attaching for placing the apparatus 10 in use, the elongate conductor 12 is simply received through the U-shaped core opening 34 and into the gap 40 and, when detaching for removing the apparatus 10 from use, the elongate conductor is simply removed from the gap 40 through the opening 34.

As should now also be appreciated, the electronic circuit 14 and the apparatus 10 are completely encapsulated and sealed with insulative material 64, 70 and are “floating”, that is, are not connected to physical ground. Further, as best seen in FIG. 7, the U-shaped core first and second legs 30, 32 are surrounded/encapsulated by the insulative material of the housing 64 thereby effectively electrically insulating and preventing the first and second legs 30, 32 from physically contacting the elongate conductor 12. Moreover, the insulative material of the housing 64 between the elongate conductor 12 and the electromagnetic coil 42 and electronic circuit 14 also effectively insulates and prevents the electromagnetic coil 42 and electronic circuit 14 from physically contacting the elongate conductor 12.

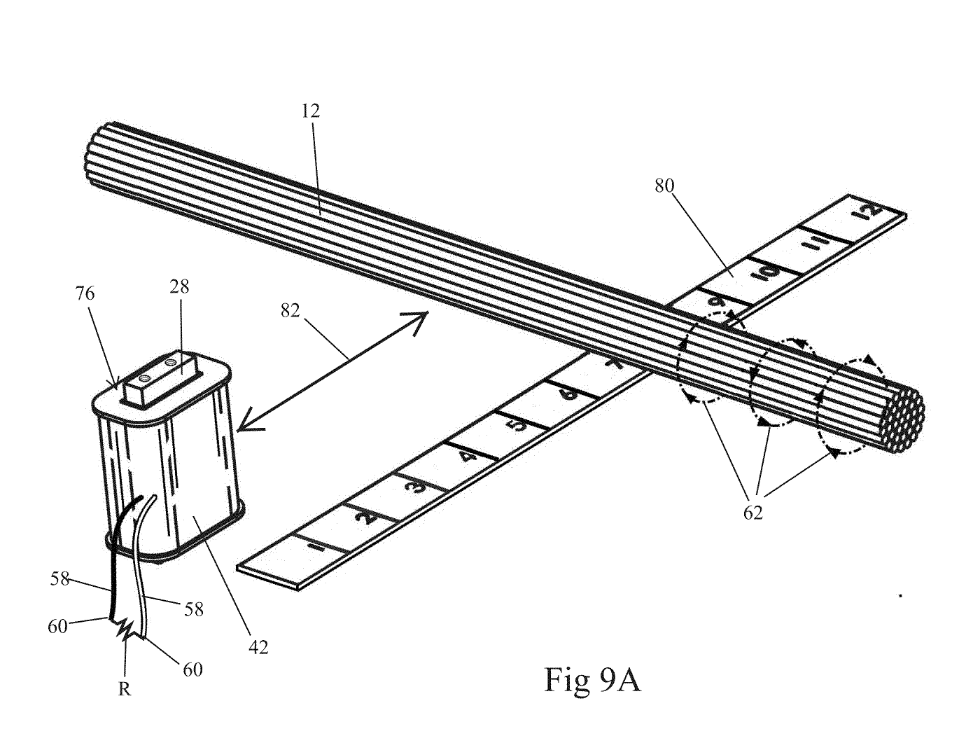

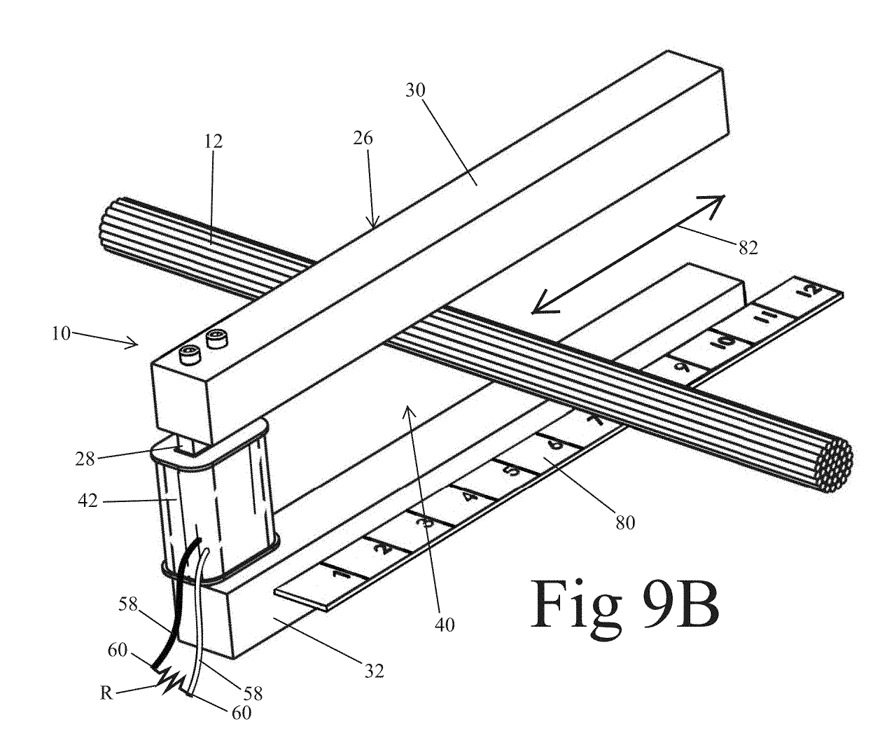

As described herein above, Applicant discovered that, although a high reluctance/large opening 34 is provided wherethrough the conductor 12 can advantageously be inserted and removed from the gap 40 between the first and second legs 30, 32, the alternating magnetic flux 62 of the conductor 12 couples with the first and second legs 30, 32 of the U-shaped core causing a significant amount of energy to be harvested by the apparatus 10. Applicant also discovered that the energy harvested by the apparatus 10 is significantly greater than, for example, a coil and core energy harvester 76 (FIG. 9A) which comprises only a central core 28 and an electromagnetic coil 42 (without the U-shaped core legs 30, 32 extending over and receiving the elongate conductor 12 within the gap 40 therebetween as described herein above with respect to Applicant's apparatus 10). The magnetic flux coupling of the elongate conductor 12 with the first and second legs 30, 32, along with the greater energy harvesting capability of Applicant's apparatus 10, as compared to the coil and core harvester 76 is demonstrated in the tests shown and depicted in FIGS. 9A and 9B and described herein below.

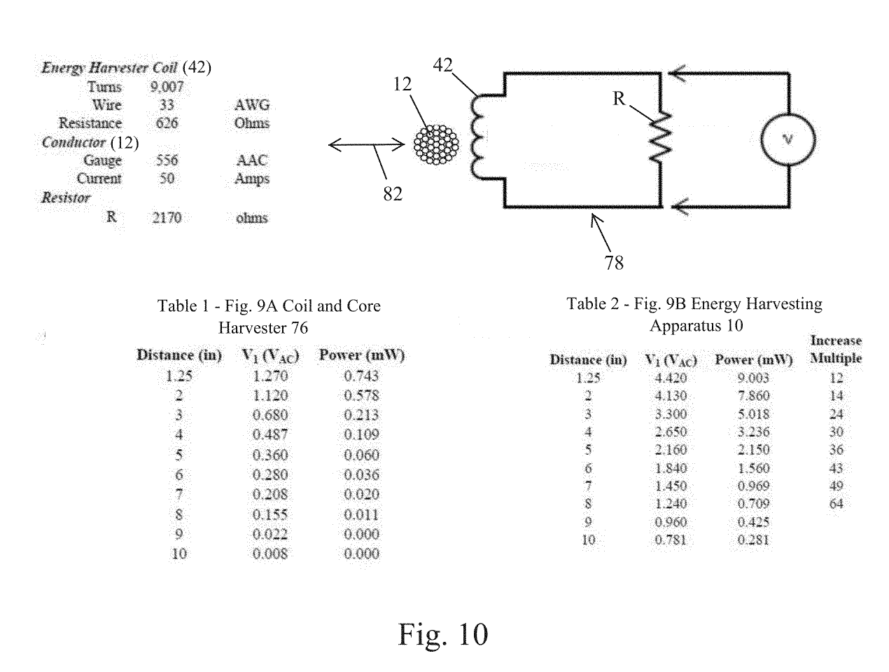

For both the tests, as depicted in FIGS. 9A and 9B, the same electromagnetic coil 42 and central core section 28 was used, and a resistor R was connected between the terminal ends 60 of the magnet wire 58. The coil 42 and resistor R thereby made a simple closed circuit 78 shown if FIG. 10. The magnet wire was 33 AWG and was wrapped 9,007 times around the central core section 28. The resistance of the coil 42 was 626 ohms. The resistor was 2,170 ohms. The same conductor 12 (type 556 AAC) was also used for both tests 9A and 9B. For both tests 9A and 9B, 50 amps were transmitted through the conductor 12 at a nominal voltage. The sole difference between the tests was that, in the test of FIG. 9B, first and second legs 30, 32 were added and secured to the central section 28, as described herein above, thereby forming a U-shaped core 26 and an energy harvesting apparatus 10 in accordance with the principles of the present invention.

During both tests 9A and 9B, the voltage across resistor R was measured, as depicted in FIG. 10 at the circuit 78, while the distance between the conductor 12 and coil 42 was incrementally varied, as depicted by arrow 82, and the distance was measured with a ruler 80. The voltage across the resistor R at selective incremental distances was recorded at the “Table 1—FIG. 9A Coil and Core Harvester 76” and at the “Table 2—FIG. 9B Energy Harvesting Apparatus 10”. Using the measured voltage (V₁) across the resister R and the resistor's value (2170 ohms), the power (mW) generated by the FIG. 9A harvester 76 and the FIG. 9B apparatus 10 was calculated using Power=V²/R.

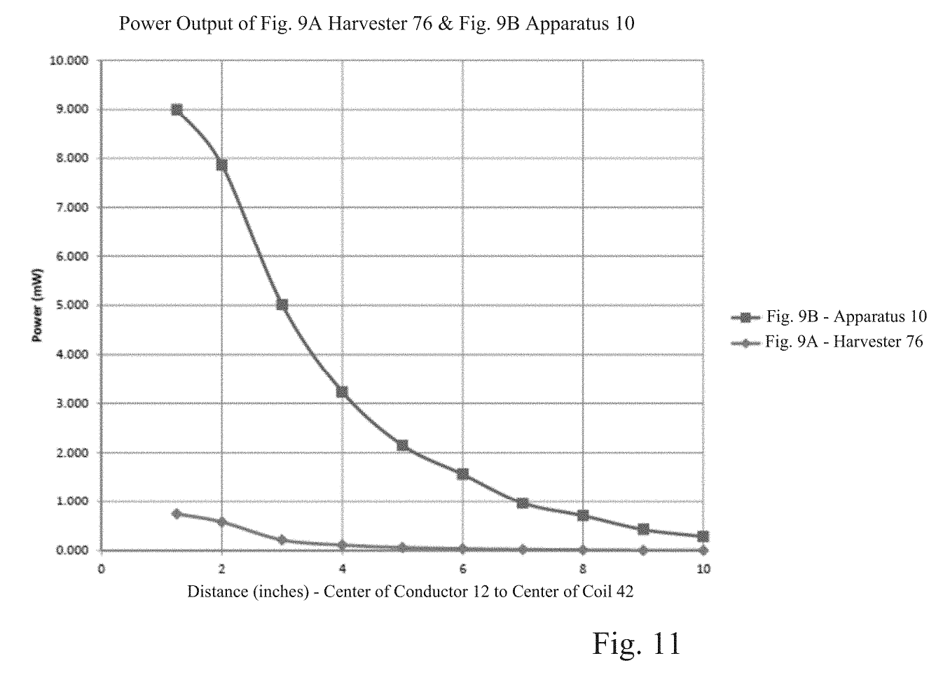

As evidenced by Table 1 and Table 2 and shown in the graphs thereof in FIG. 11, the harvested energy/power output of the FIG. 9B Apparatus 10 was significantly greater than the FIG. 9A coil and core harvester 76. Moreover, the difference between the respective power outputs increased as the distance between the conductor 12 and the coil 42 increased (see the “Increase Multiple” column in Table 2).

While this invention has been described as having an exemplary design, the present invention may be further modified within the spirit and scope of this disclosure. This application is therefore intended to cover any variations, uses, or adaptations of the invention using its general principles.

What is claimed is:

1. A method of harvesting electrical energy from an elongate conductor through which alternating electrical current is traveling, the method comprising the steps of:
providing a U-shaped core comprising a central section and first and second legs extending from the central section, and defining an opening leading to a gap between the first and second legs, wherein the opening and gap are larger than a cross section of the elongate conductor and wherein the central section and the first and second legs comprise magnetically permeable material;
providing an electromagnetic coil comprising magnet wire wound around the central section and having terminal ends;
inserting the elongate conductor though the opening and into the gap between the first and second legs;
preventing the elongate conductor from physically contacting the first and second legs and the electromagnetic coil;
electromagnetically coupling the alternating electric current traveling through the elongate conductor with the U-shaped core and inducing electric current in the electromagnetic coil and providing electric current at the magnet wire terminal ends; and,
during the step of electromechanically coupling, maintaining the opening open for selectively removing the elongate conductor therethrough.

2. The method of claim 1 wherein, during the step of providing a U-shaped core, further comprising the step of constructing the U-shaped core by stacking a plurality of U-shaped sheets, wherein each U-shaped sheet comprises a central section and first and second legs extending from the central section.

3. The method of claim 1 wherein, during the step of providing a U-shaped core, further comprising the step of constructing the U-shaped core of ferromagnetic metal.

4. The method of claim 1 wherein, during the step of providing an electromagnetic coil, further comprising the step of winding the magnet wire around the central section more than 5,000 times.

5. The method of claim 1 further comprising the steps of:
coupling the magnet wire terminal ends to and powering an electronic circuit for sensing and transmitting via electromagnetic radiation the operational status of the elongate conductor; and,
encapsulating the U-shaped core, the electromagnetic coil and the electronic circuit within an insulative housing.

6. The method of claim 5 further comprising the step of securing the insulative housing to an insulator supported on an elongate pole and which supports the elongate conductor.

7. The method of claim 6 wherein, during the step of providing a U-shaped core, further comprising the step of constructing the U-shaped core by stacking a plurality of U-shaped sheets, wherein each U-shaped sheet comprises a central section and first and second legs extending from the central section.

8. An apparatus for harvesting electrical energy from an elongate conductor through which alternating electrical current is traveling, the apparatus comprising:
a U-shaped core comprising a central section and first and second legs extending from the central section, and defining an opening leading to a gap between the first and second legs;
the central section and the first and second legs comprising magnetically permeable material;
an electromagnetic coil comprising magnet wire wound around the central section and having terminal ends;
wherein the elongate conductor is received though the opening and is located in the gap between the first and second legs, and does not physically contact the first and second legs and the electromagnetic coil, whereby the alternating electric current traveling through the elongate conductor electromagnetically couples with the U-shaped core and induces electric current in the electromagnetic coil thereby providing electric current at the magnet wire terminal ends.

9. The apparatus of claim 8 wherein the magnetically permeable material forming the U-shaped core is paramagnetic.

10. The apparatus of claim 8 wherein the magnetically permeable material forming the U-shaped core comprises ferromagnetic metal.

11. The apparatus of claim 8 wherein the U-shaped core central section and first and second legs are integrally formed.

12. The apparatus of claim 8 wherein the first and second legs are secured to the central section with fasteners.

13. The apparatus of claim 8 wherein the U-shaped core comprises a plurality of stacked U-shaped sheets, wherein each U-shaped sheet comprises a central section and first and second legs extending from the central section.

14. The apparatus of claim 8 wherein the magnet wire is wound around the central section more than 5,000 times.

15. The apparatus of claim 8 wherein the magnet wire is 33 AWG and is wound around the central section more than 9,000 times.

16. The apparatus of claim 8 wherein the first and second legs are encapsulated with an insulative material.

17. The apparatus of claim 8 further comprising an electrically insulative material layer between the elongate conductor and the U-shaped core and electromagnetic coil.

18. The apparatus of claim 8 wherein the magnet wire terminal ends are coupled to and power an electronic circuit for sensing and transmitting via electromagnetic radiation the operational status of the elongate conductor, and wherein the U-shaped core, the electromagnetic coil and the electronic circuit are encapsulated within an insulative housing.

19. The apparatus of claim 18 wherein the insulative housing is secured to an insulator supported on an elongate pole and which supports the elongate conductor.

20. The apparatus of claim 19 wherein the U-shaped core comprises a plurality of stacked U-shaped sheets, wherein each U-shaped sheet comprises a central section and first and second legs extending from the central section.
